(19) United States
(12) Patent Application Publication
(10) Pub. No.: US 2003/0095310 A1
(43) Pub. Date: May 22, 2003

(54) Optical communication apparatus and method

(75) Inventors: Axel Tillmann, Upton, MA (US); Vladimir Novikov, Worcester, MA (US)

Correspondence Address: HALE AND DORR, LLP, 60 STATE STREET, BOSTON, MA, 02109

(73) Assignee: Novilit, Inc., Marlborough, MA (US)

(21) Appl. No.: 10/085,440

(22) Filed: Feb. 28, 2002

Related U.S. Application Data
(63) Continuation-in-part of application No. 10/054,216, filed on Nov. 13, 2001.
Application No. 10/054,216 is a continuation-in-part of application No. 09/360,224, filed on Jul. 23, 1999, now Pat. No. 6,356,950.
Application No. 09/360,224 is a continuation-in-part of application No. 09/228,015, filed on Jan. 11, 1999, now abandoned.

(51) Int. Cl. H04J 14/02

(52) U.S. Cl. 359/133

(57) ABSTRACT

An optical signal processor and method use a signal router having a plurality of optical switches arranged in a connection structure with each switch having an optical input port, optical output ports, and a control port for controlling the optical connection between the input ports and the output ports. A control generator has a plurality of electrically controlled optical energy sources, each source being optically connected to at least one of the control ports. Each source has an electrical signal input control and an optical energy output control which responds to the electrical control signal. A processor translation system can flexibly generate and control the electrical signals input to the plural control ports for configuring the connection structure thereby managing the optical route of the optical input signal through the processing system to a selected output port. The optical processing method optically switches optical signals using flexible optical switching circuitry. In the various systems, an all optical path is provided from the optical input to optical output.

### CROSS-REFERENCE TO RELATED APPLICATIONS

This application is a continuation-in-part application of U.S. application Ser. No. 09/228,015, filed Jan. 11, 1999.

### BACKGROUND

This invention relates to processing of digital communication.

Communication processing devices are used in data and telephone communication systems, including wide area data communication networks, telephone networks, satellite communication networks, in-vehicle automobile communication systems, naval communication systems, home appliances, and retail devices. In the context of the description that follows, a communication processing device is almost any device that accepts and processes input flows of information and as a result acts on the input flows or produces output flows of information from those input flows. Communication processing devices may be implemented in software or as special purpose hardware, or using a combination of software and special purpose hardware. Examples of communication devices include data routers, which take input information flows and produce output information flows, and multimedia terminals, which take input information flows and acts on those input flows to present multimedia information to a user.

Operation of communication processing devices is typically specified in a variety of ways. In particular, the communication protocols used on the input and output flows are often specified in communication standards written in English or some other “human” language, possibly augmented using diagrams and picture. The operation of the devices typically focuses on the communication protocols used on the input and output flows. These specifications are then used as the basis of software implementations (e.g., in C, C++, Assembler, FlexLogic description) or as the basis of circuit designs.

### SUMMARY

In one aspect, in general, the invention is a method for processing a data signal, for instance, a data signal encoding a data bit stream which carries a sequence of data packets. The method includes accepting a protocol specification that includes specification of a number of elements, each specification including a length and a name, and optionally internal structure and actions. For instance, the elements are sub-packets or data fields. The method also includes accepting a series of data packets and for each accepted packet, associating portions of the input packet with elements specified in the protocol specification. For each of the associated portions of the input packet, the method includes performing actions included in the specification of elements associated with that portion of the input packet, for example by use of a subroutine call or passing a data message..

The invention can include one or more of the following features:

The specification of an action includes a specification of a programming language statement, such as a C++ statement, and wherein performing actions included in the specification of elements includes executing the programming language statement.

The method includes processing the protocol specification to produce executable software, and execution of the software implements the functions of associating portions of input packets with elements specified in the protocol specification and performing actions associated with elements specified in the protocol specification.

The protocol specification includes an object-oriented specification of elements, wherein names of components of an element are local to that element.

The protocol specification includes an association of numerical values and symbolic names for an element.

The method of can include processing the protocol specification to produce a hardware description, and wherein performing actions included in the specification of elements includes sending a message identifying a specified action.

Aspects of the invention include one or more of the following advantages.

By specifying a packet format using a formal, unambiguous language, various hardware and software based implementations can be automatically formed without the risk of introducing human error.

Implementations for different target environments, can be produced by processing the same protocol specification, thereby reducing human effort.

Specifying a protocol using a formal, unambiguous language allows development of completely unambiguous protocol standards, and therefore offers true interoperability between implementations of such developed standards.

The formal language allows development and implementation of complex protocols, in part because the specification is concise and includes built-in error handling capabilities. Furthermore, the language can be used to directly specify hardware protocol processors, for example, including direct solution trees for the specified communication protocol.

A protocol specification written in this formal language can be used to automatically build of configure test systems for devices that communicate using the protocol, and to automatically build or configure communication analyzers which monitor communication according to the protocol.

Multiple different protocols specified according to the formal language can coexist in a single implementation.

Other data series or information streams can also be processed according to a protocol specification. For example, chemical analysis sequences or DNA sequences can be processed according to the invention.

Other features and advantages of the invention are apparent from the following description, and from the claims.

### DESCRIPTION OF DRAWINGS

FIG. 1 is a first general view of a communication processing device that makes use of a packet decoder to process a sequence of input packets;

FIG. 2 is a second general view of a communication processing device that makes use of a packet decoder to process a sequence of input packets, a packet generator to create a sequence of output packets, and a state machine coupled between the packet decoder and packet generator;

FIG. 3 illustrates a procedure for generating executable software for a software-based communication processing device, and shows a block diagram of a communication processing device;

FIG. 4 is a logical block diagram of software modules of the executable software used in a software-based embodiment;

FIG. 5 illustrates an exemplary packet structure;

FIGS. 6A-B are a protocol specification for the exemplary packet structure;

FIG. 7 illustrates a particular type of information element packet;

FIG. 8 is a protocol specification of the particular type of information element packet;

FIGS. 9A-G contain exemplary source code that is generated from a protocol specification; and

FIG. 10 is a tree-structured representation of a protocol.

### DESCRIPTION

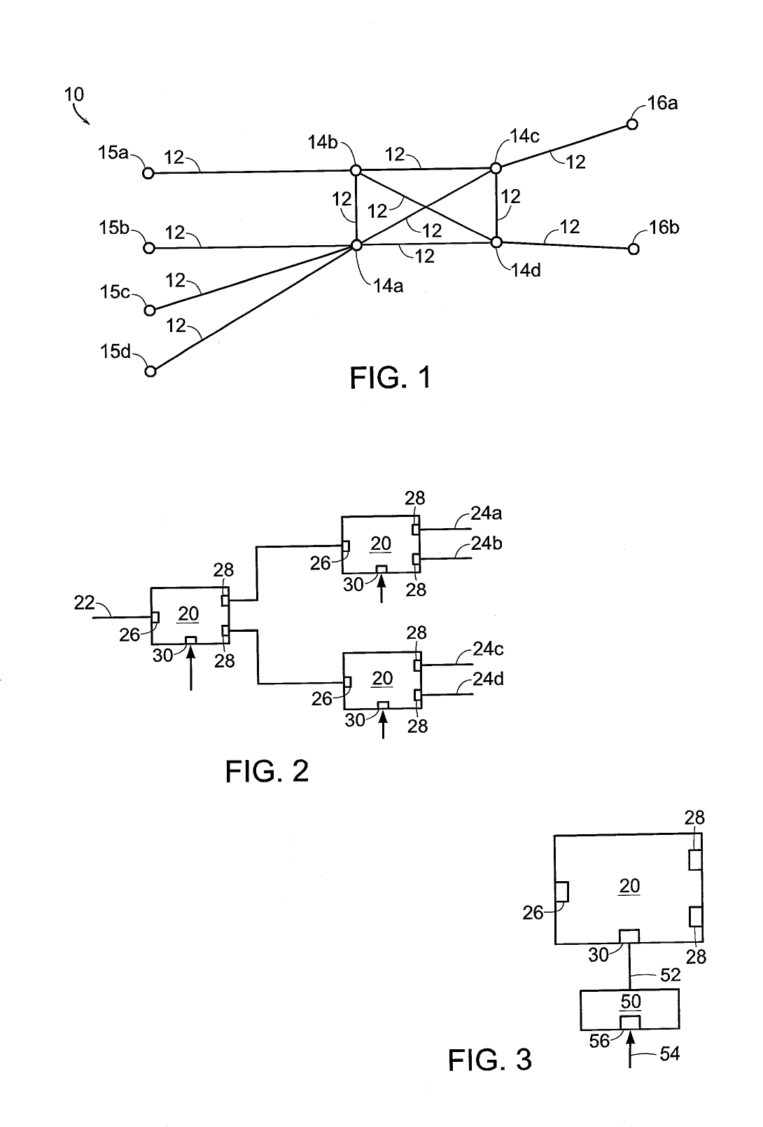

1 System Overview (FIG. 1)

Referring to FIG. 1, in a first general view of a number of alternative embodiments of the invention, a communication processing device 100 accepts and processes a data signal 125. Data signal 125 is first segmented into a packet sequence 115 by a packet detector 120. Each of the packets in packet sequence 115 is processed in turn by packet decoder 110. Packet decoder 110 processes the packets according to a protocol specification 140, which includes definitions of one or more packet types. These definitions include the structure and meaning (syntax and semantics) of the packets, as well as the required actions to take when various elements of the packets are present. For each packet that it processes, packet decoder 110 performs actions that are specified in protocol specification 140. In this embodiment, packet decoder 110 produces zero, one, or more parameterized messages 135, or other types of signals, that it passes to a message processor 130. Message processor 130 makes use of the information in messages 135 to produce a result, such as presenting the information in the input packets to a user. In other embodiments described below, the actions performed by packet decoder 110 as a result of processing packets include executing subroutine calls and other program statements specified in protocol specification 140, or updating internal state values (variables) in the protocol decoder itself.

The general structure shown in FIG. 1 is used in a variety of applications. In one exemplary application, communication processing device 100 accepts digitized multimedia information as data signal 125 according, for instance, to an MPEG standard. The multimedia information may include a multiplexed video, audio, and other data. Packet detector 120 finds individual packets (or “frames”) based, for instance, on synchronization data in data signal 125 or on electrical characteristics (e.g., voltage levels) of the data signal between packets. Packet detector 120 sends a finite length bit sequence to packet decoder 110 for each packet it finds. In this exemplary application, some packets may contain audio data in one format while other packets contain video data in another packet format. Some of the video packets may indicate that they are the start of a new video frame, while other video packets may contain addition data for a current video frame. Packet decoder 110 processes the bit stream for each packet it receives from packet decoder 120 in turn. For each packet, if the packet's structure matches the structure of packets described in protocol specification 140, packet decoder 110 outputs typically one or more messages 135 to message processor 130. Each message 135 has a type, and in general, includes a number of parameters that are determined by packet decoder 110 from the input bit stream for the packet being processed. To illustrate the types of messages generated in the exemplary case of multimedia decoding, the messages may functionally include “create new audio stream (stream id),” or “new audio samples for data stream (stream id, data).” Message processor 130 receives these messages, and acts on them using the received information, for example, by displaying video on a monitor and playing the audio on speakers.

Referring to FIG. 2, a second general view of a number of other alternative embodiments of the invention is similar to that shown in FIG. 1. In these embodiments, communication processing device 200 includes a packet detector 120 and packet decoder 110 as in communication device 100 (FIG. 1). In addition, communication processing device 200 includes a packet generator 210, which forms packets that have formats defined by protocol specification 140, and a packet constructor 220 that accepts a packet sequence from packet generator 210 and forms a data signal 225 that includes the packets as well as indicators in the data signal of the boundaries between packets. As with data signal 125, which is input to the device, data signal 225, which is output from the device, may alternatively indicate packet boundaries in the output data stream or using characteristics of the signal itself.

Communication processing device 200 also includes a state machine 230. State machine 230 accepts messages 235 from packet decoder 110 and maintains a stored state based on past input packets. After packet decoder 110 completes processing a packet that is provided to it by packet detector 120, and has issued all the messages that are based on that processing, it does not necessarily maintain any history or memory of that packet. State machine 230 on the other hand can maintain such a history. In response to messages 235 that it receives from packet decoder 110, and on its stored state, it issues messages 245 to packet generator 245 and updates its stored state. In addition, packet decoder 110 passes messages 240 directly to packet generator 210. Such direct messages can be used by packet generator 245 to generate an output packet, such as an acknowledgment packet, while packet decoder 110 is still processing an input packet.

The structure shown in FIG. 2 is used in a variety of applications. In one exemplary application, communication processing device 200 accepts a data signal 125 that encodes an information stream according to a first format (or protocol) and produces a new data signal 225 that encodes the same information stream according to a second format (protocol), which is different than the first.

Also, although communication processing device 200 is illustrated with a single input data signal 125 and a single output data signal 225, in various alternative embodiments there are multiple of each. Also, communication processing device 200 may be coupled to another communication device, and accept data signal 125 from that device and provide data signal 225 back in return. In this latter case, for instance, packet generator 210 is responsible for generating acknowledgement packets when data packets are received from the other device.

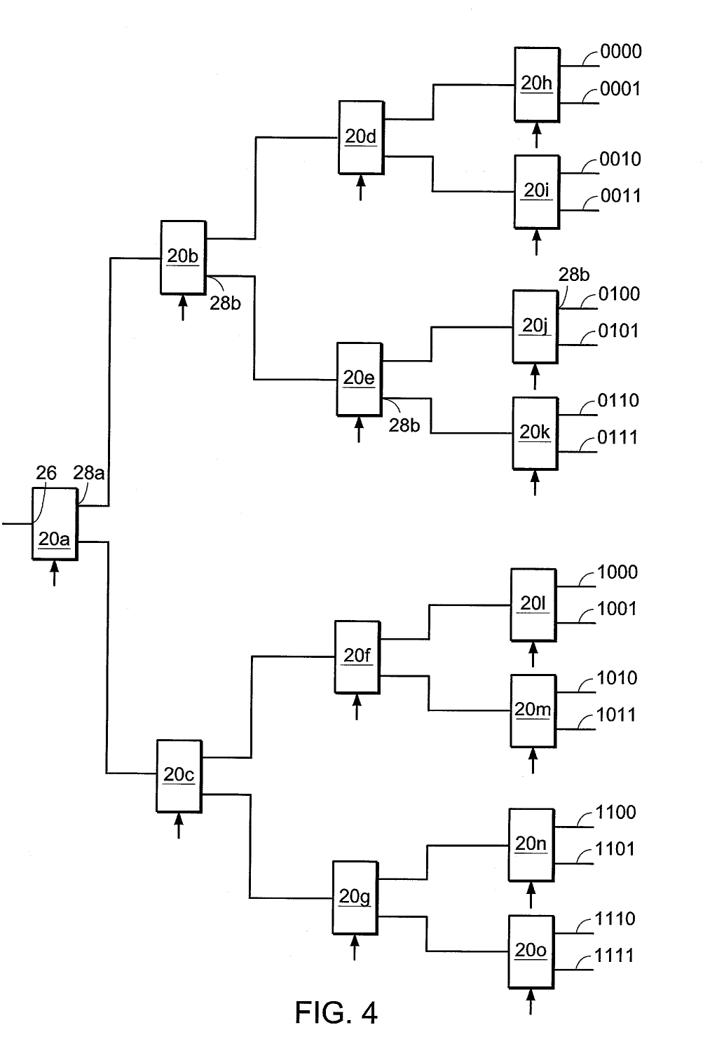

2 Software Embodiment (FIGS. 3-4)

Various embodiments of the invention are software-based, hardware-based, or use a combination of hardware and software. The description that follows is directed at software embodiments in which packet decoder 110, message processor 130, state machine 230, and packet generator 210 are implemented as software modules that execute on a general purpose programmable processor or device controller. Several alternative embodiments, both software- and hardware-based are described in Section 5.

Referring to FIG. 3, a software-based embodiment of the general type shown in FIG. 1 makes use of protocol specification 140 to generate executable software 340. Executable software is executed on a processor 360 in communication processor 100. In this embodiment, communication processor 100 includes processor 360, which is used to execute executable software 340, an input interface 365 for generating packet sequence 115, and working storage 370, which is used by processor 360 while running executable software 340.

Executable software 340 is generated from protocol specification 140 in several steps. First, a specification compiler 310 accepts protocol specification 140 and generates packet decoder source code 320. For instance, specification compiler 310 accepts protocol specification 140 in a syntax described below in Section Error! Reference source not found and produces packet decoder source code in the syntax of the C++ programming language. In addition to protocol specification 140, message processing source code 325, for instance also specified in the syntax of the C++ programming language, defines how individual messages generated by packet decoder 110 will be processed. Finally, communication processor source code 315 includes a specification of overall routines to be executed by the communication processing device, for example, including input routines to accept packet sequence 115 and routines to invoke the routines defined in packet decoder source code 330.

A source code compiler 330, for example a C++ language compiler and associated link editor, accepts communication processor source code 315, packet decoder source code 320, and message processor source code 325, and produces executable software 340. Executable software 340 is transferred to a software storage 350, for instance a magnetic disk or a semiconductor storage in communication processing device 110, for execution by processor 360.

Referring now to FIG. 4, in one software-based embodiment, communication processor executable software 340 includes three modules. These are packet decoder module 420, which corresponds to packet decoder source code 320 (FIG. 3), message processor module 425, which corresponds to message processor source code 325 (FIG. 3), and communication processor module 415, which corresponds to communication processor source code 315 (FIG. 3). A routine in communication processor module 145 inputs packet sequence 115, for example by reading from a hardware register in input interface 365 (FIG. 3). For each packet it inputs, it calls a main routine in packet decoder module 420. Packet decoder module 420 processes the packet, and calls a number of message processors 435, which are implemented as subroutines in message processing module 425. Each of these subroutine calls corresponds to passing a message between packet decoder 110 and message processor 130 in FIG. 1. In operation, message processors 435 are generally associated with occurrence of particular fields in an input packet, and they are called with a parameter that holds the particular value of the field in the input packet.

In the software embodiment described about in relation to FIGS. 3-4, passing messages between packet decoder 110 and message processor 130 (FIG. 1) corresponds to software in packet decoder module 420 (FIG. 4) making subroutine calls to routines in message processor module 425. Alternative software embodiments do not necessarily make use of such a subroutine call communication mechanism. For instance, a message queue can used whereby code in packet decoder module 130 puts messages in the queue and routines in message processor module 425 dequeue the messages. Alternatively, in an event-driven programming approach, different message processors 435 are associated with different message types, and are invoked automatically by a central messaging service when messages of their associated type are sent.

3 Protocol Specification

A particular embodiment of the syntax used for protocol specification 140 is described in this section. Alternative embodiments may use somewhat different syntax to achieve equivalent results. For instance, alternative ways of associating particular messages or message processor routines with occurrence of fields in an input packet may be used.

Referring back to FIGS. 1-2, communication processing devices 100 and 200 make use of a protocol specification 140 for processing packets in input data signal 125 and for creating packets form output data signal 225. In the software embodiment described about with reference to FIGS. 3-4, protocol specification 140 is used to generate executable software 340 (FIG. 3) that is executed of a software-based implementation of communication processing device 100.

Protocol specification 140 includes a specification of allowable packet formats (or structures), including, for example, lengths of data fields and allowable values for those fields. In general, protocol specification 140 includes a hierarchical description of allowable packet formats. A packet format can be described as a succession of sub-packets or data fields, and each sub-packet can be further described as a succession of still other sub-packets and data fields, until the entire packet is accounted for with data fields. Protocol specification 140 includes definitions of the packets and data fields. Data fields include specifications of the number of bits allocated to the field, and optionally an association of numeric values and symbolic names. Packet and sub-packet definitions include specifications of allowable sequences of sub-packets or data fields.

In the description of the syntax of protocol specification 140 that follows, elements in square brackets (“[ . . . ]”) are options, boldface elements are keywords of the specification language, italicized elements represent parameters or other defined elements, and elements bracketed by parentheses and separated by vertical bars (“( . . . | . . . )”) indicate choices of elements.

At the top level of a protocol specification, the syntax of protocol specification 140 includes a packet statement that has the following syntax:

[modifier] packet (argument) [{definition}]

where argument includes a name, and optionally maximum length of the packet with the syntax

argument=qualified_name [, length ]

and modifier determines the units of length and can be one of bit, octet, auto, zstr (zero terminated string), or str (string). The structure of the packet is contained in the definition portion, which is described below.

In the simplest situation, a packet is defined as a fixed length bit sequence, such as

packet sample (“sample name”, 80)

which indicates that a packet always has exactly 80 bits, and is named “sample name.”

More typically, a packet includes sub-elements. The definition section specifies these sub-elements. For example, a field statement which has the following structure is used:

[modifier] field (argument) [{definition}]

The field statement is similar to the packet statement, except that a field cannot be defined in terms of other packets and fields. That is, it is a terminal element of the grammar that specifies the position of a value encoded in a packet.

To illustrate the use of field statements, a sample packet can be specified as follows:

packet sample (“sample one”, 80 ) {

field(“first field”,32)
field(“second field”,32)
field (“third field”,16)

}

The definition portion of a field statement can be used to associate values, such as numeric constants, with symbolic names that are passed as the parameters of the messages corresponding to that field. The definition portion of the statement is also used to define the action the packet decoder should take when it encounters this field.

As an illustration of use of the definition portion of a field statement to associate values with symbolic names, the definition of the third field in the example above can be replaced with

field(“third field”,16) {

alt{1: “value one” 2: “value two”

3: “value three” rest: “another value” }

}

so that if a packet is processed in which the last 16 bits of the 80 bit packet have the value 1, the message “third field(value one)” is sent. The rest entry corresponds to a default if none of the enumerated values is chosen.

The definition portion of a packet or field statement can include a repetition of a sequence of one or more fields or nested sub-packets. For example, the definition portion can include the expression

repeat{ field(“repeated field a”,8)

field(“repeated field b”,8) }

to signify that the fields “repeated field a” and “repeated field b” alternate until the data in the packet is accounted for.

The definition of nested packets can be included within a definition, or can be specified separately, thereby making the specification more readable, and, if the same sub-packet is used in several places, centralizes the definition of that sub-packet.

Field values can be used with the var construct in place of parameters such as field lengths, and can be used in arithmetic expressions in which a value is computed. Such a use is shown in the following example

packet sample (“sample two”) {

field(“packet byte length ”,16)
field(“payload”,var(“packet byte length)*8-16)

}

Field values can also be used to determine the format of subsequent portions of a packet. For instance, in the following example, the value of an initial field determines the format of subsequent portions of the packet:

packet sample (“sample three”) {

field(“payload type”, 8)
alt(var(“payload type”)) {

0: packet(“subpacket type zero”)
1: packet(“subpacket type one”)

}

}

Although in many cases, packets can be processed in bit sequence order, that is, the structure of future bits in a packet depends on values, if any, that occur in past bits. When this is not the case, the protocol specification allows a “lookahead” syntax. In particular, la(offset,length) is a value that starts offset bits from the current field and has a length length.

Also, there are situations in which it is not possible or straightforward to predict which of several possible packet formats are consistent with an input bit sequence. However, considering the entire packet as a whole, only some packets are consistent with the values. The any construct signifies that one or more or the definitions may account for the data in the packet, but no messages are sent unless the entire packet is consistent with the structure. In the case that multiple of the formats are consistent with the data, the first listed is chosen. An example of use of the any construct is as follows:

packet sample (“sample four”) {

alt {

packet(“packet type zero”)
packet(“packet type one”)

}

}

The definition portions of field statements are also used to specify the actions that the packet decoder is to take when it encounters a field. An arithmetic assignment statement or subroutine call can be specified using variables corresponding to field values. C++ operators are enclosed in <: and :> brackets, and field variables are referenced using the var( ) construct described above. For example, the statement

var(“fielda”)<:=:> var(“fieldb”)<:+:> var(“fieldc”) sets the value of the fielda field to be the sum of the values of the fieldb and fieldc fields.

A second example of an action specification is a call to a subroutine, for example, specified as

<:ActionSubr(:> var(“fielda”) <:):>

for a call of the subroutine named ActionSubr with its argument being the value of the fielda field.

In the above description, field names are indicated as strings. The specification syntax uses a nested packet and field names to fully specify a field. For example, the field “a field” in a packet named “the packet” is fully specified as “the packet”:“a field”. A field name that is prefixed with a colon signifies that it is already a fully qualified name, that is, it is not prefixed by the higher level packet names.

The packet specifications are object-oriented in that the scope of field names is local to the packet (or sub-packet) being defined. This allows the same packet definition to be used repeatedly in a protocol without having conflicting field names.

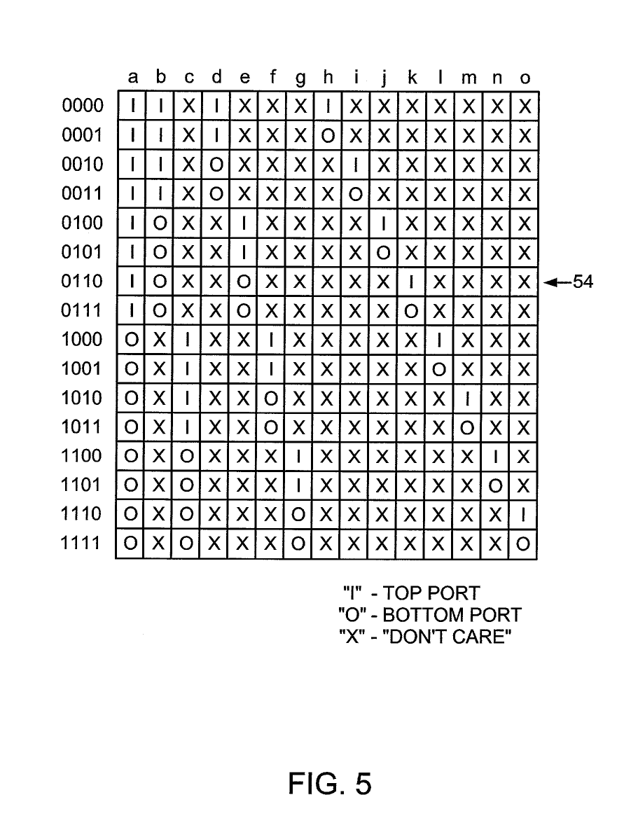

4 Exemplary Protocol Specification (FIGS. 5-9F)

In order to illustrate the form of a protocol specification, a portion of the specification of packets in a ITU-T Q.2931 (B-ISDN Application Protocol) communication protocol is described. In particular, the protocol includes a class of packets called “information elements.” Within this class of packets, one particular packet type is a “Broad-band Bearer Capability” packet. In the description below, the specification of the class of information element packets is described, as well as a specification of the particular broad-band bearer class packet.

Referring to FIG. 5, the general format of an information element packet 500 includes a series of 8-bit units (bytes) each illustrated as one row in the figure. The first byte is an “identifier” 510 that specifies the type of the information element. The next byte 520 includes additional fields. The next 16 bits, bytes 530 and 532, is “contens len,” which is the entire length of packet 500. This is followed by the contents 540 itself, which in general includes multiple bytes. The format of contents 540 depends on the value of “identifier” 510 in the first byte of packet 500.

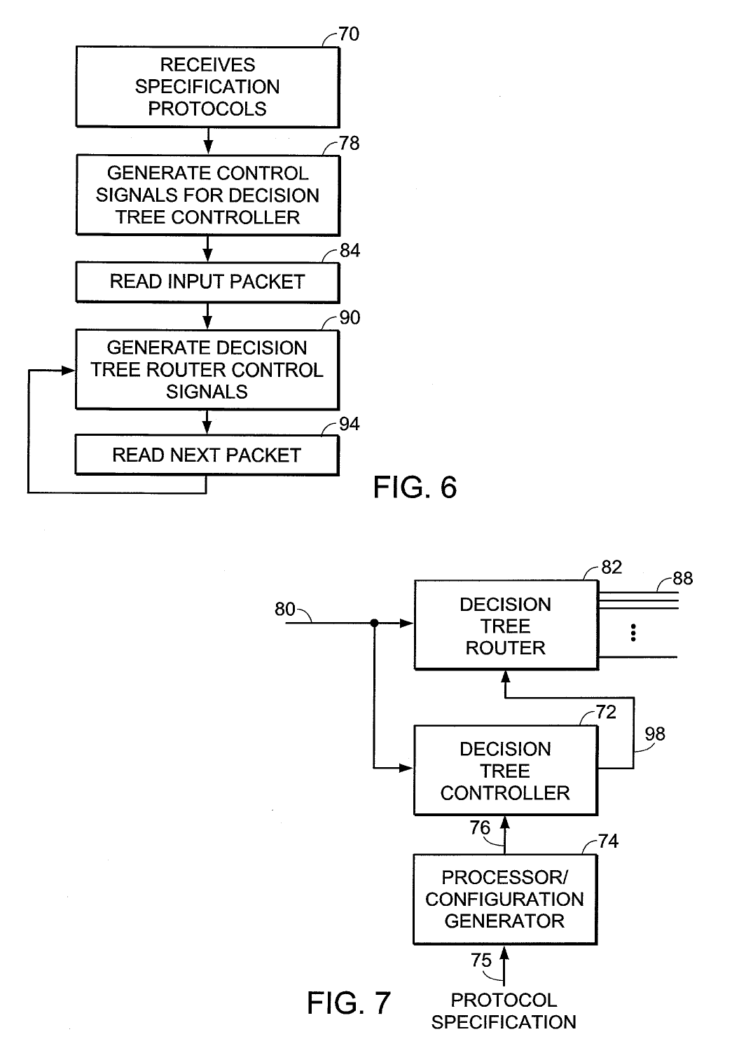

Referring to FIGS. 6A-6B, a specification of this packet is shown as it appears in protocol specification 140 (FIGS. 1-2), including associations of particular values of fields with symbolic names appropriate to the protocol. Lines 100 (FIG. 6A) through 177 (FIG. 6B) define the format of information element packet 500 (FIG. 5). Lines 101 through 131 define the first 8-bit field, identifier 510 (FIG. 5). In addition to naming the field and specifying the length of the field to be 8 bits at line 101, lines 102 through 130 associate particular values of the file with symbolic constants. When the packet decoder processes the first byte of an input packet according to this specification, it sends an “identifier” message with the parameter being the symbolic names associated with the actual value. Lines 132 through 142 similarly define the fields in the second byte 520 of information element packet 500. Line 143 both defines the next 16-bit field, “contens len,” and also specifies using the len construct that the entire information element packet has a bit length specified by this field.

Turning to FIG. 6B, the remainder of the protocol specification uses an alt construct to specify that the remainder of the packet is a sub-packet, and that the particular sub-packet type depends on the value of “identifier” which was located at the first byte of the packet. Note that at line 153, the specification indicates that if identifier is equal to 0x5e (01011110₂) then the remainder of the packet is a “broad-band bearer capability” packet.

Turning to FIG. 7, a broad-band bearer capability information element 700 includes a first byte 710 in which identifier equals 0x5e, and bytes 720, 730, and 732 of the same form as in the generic information element packet 500 (FIG. 5). Bytes 740, 750, and 750 are formatted according to the “broad-band bearer capability” protocol specification.

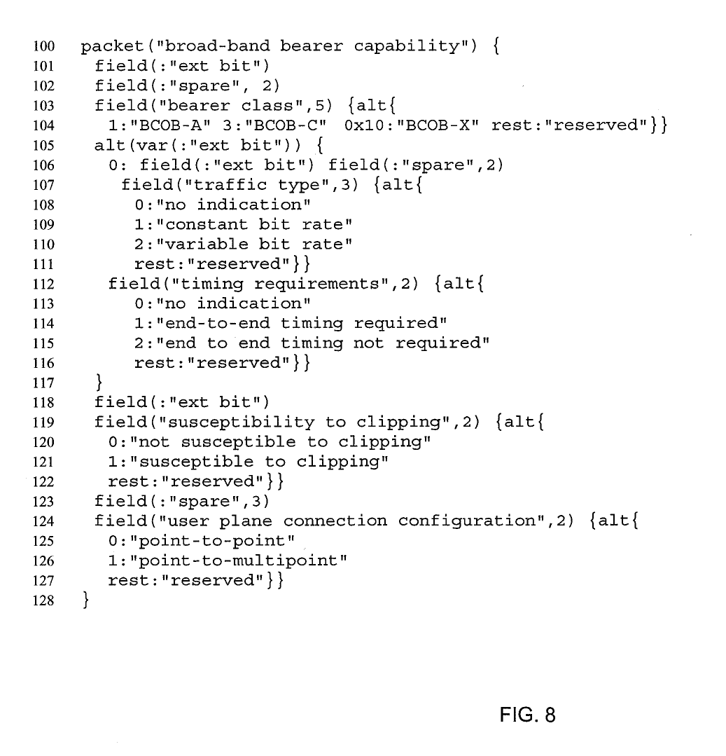

Turning to FIG. 8, the broad-band bearer capability packet (a sub-packet of an information element packet) is specified using similar specification constructs as shown in FIG. 5. Lines 101 through 104 specify a byte 740 (FIG. 7), the first byte of the contents which is specific to a broad-band bearer capability packet. Lines 105 through 117 define the format of a next byte 750 (FIG. 7) which is present only if the “ext bit” field 742 (FIG. 7, specified at line 101) of the first byte 740 is equal to 0. Lines 118 through 127 define the format of the last byte 760, which is always present.

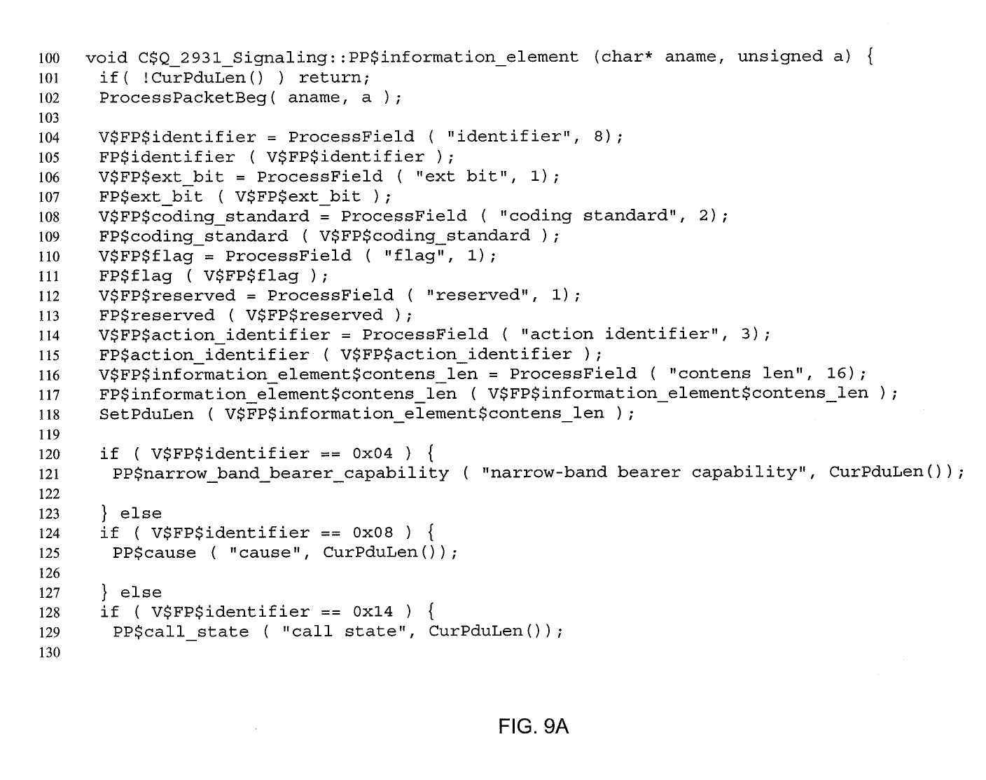

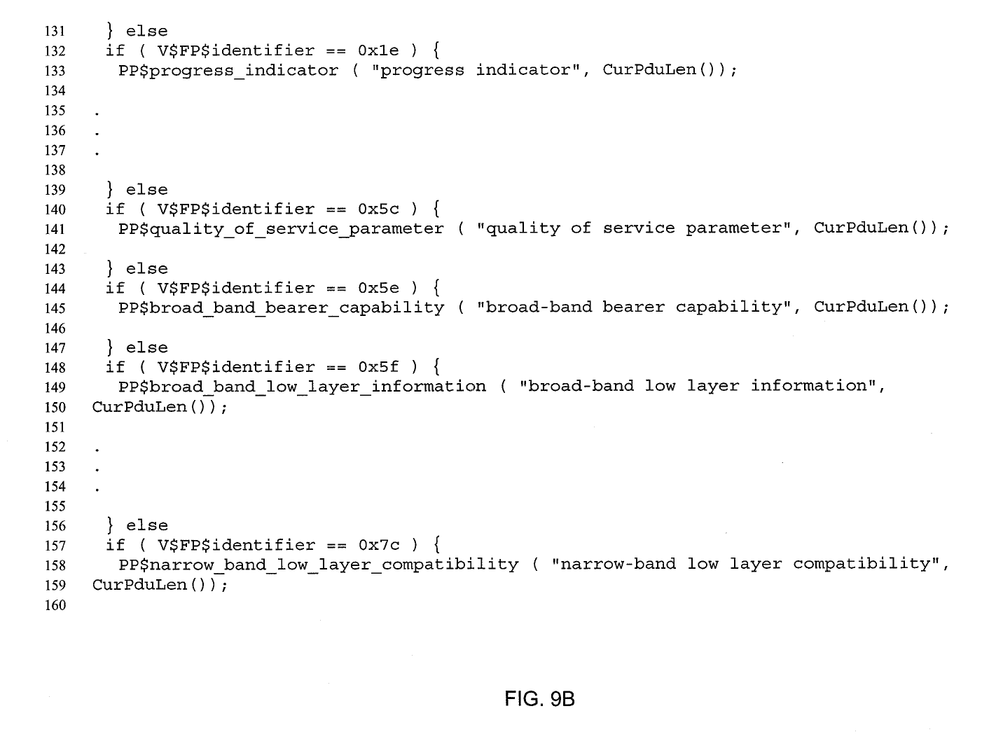

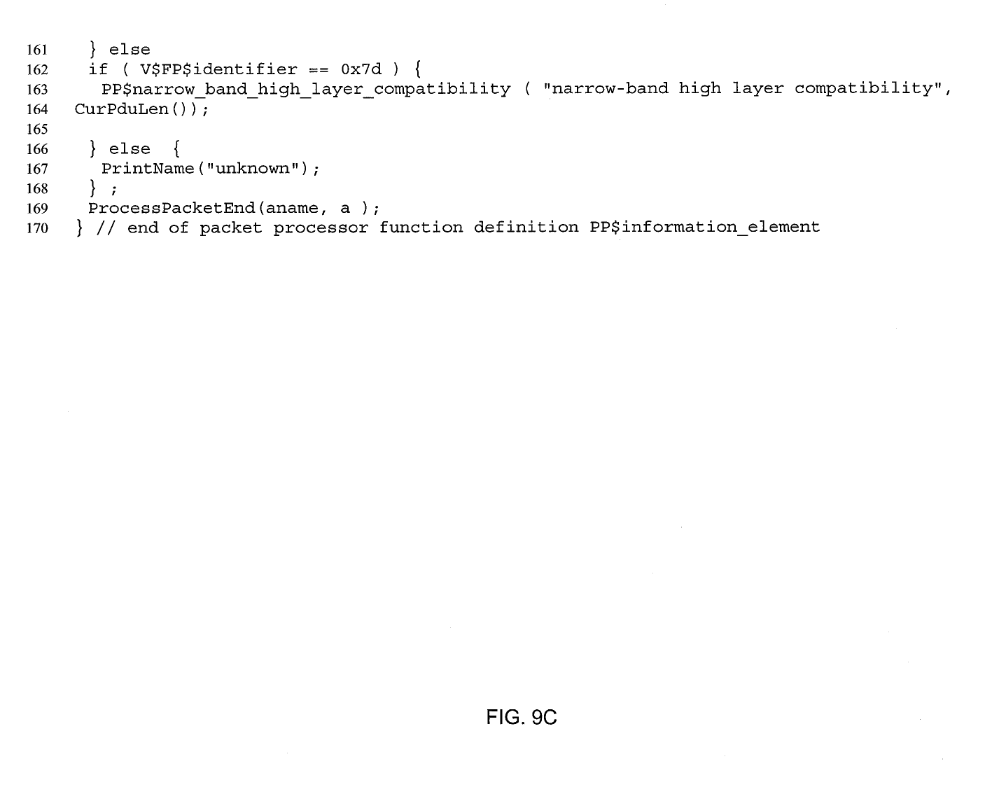

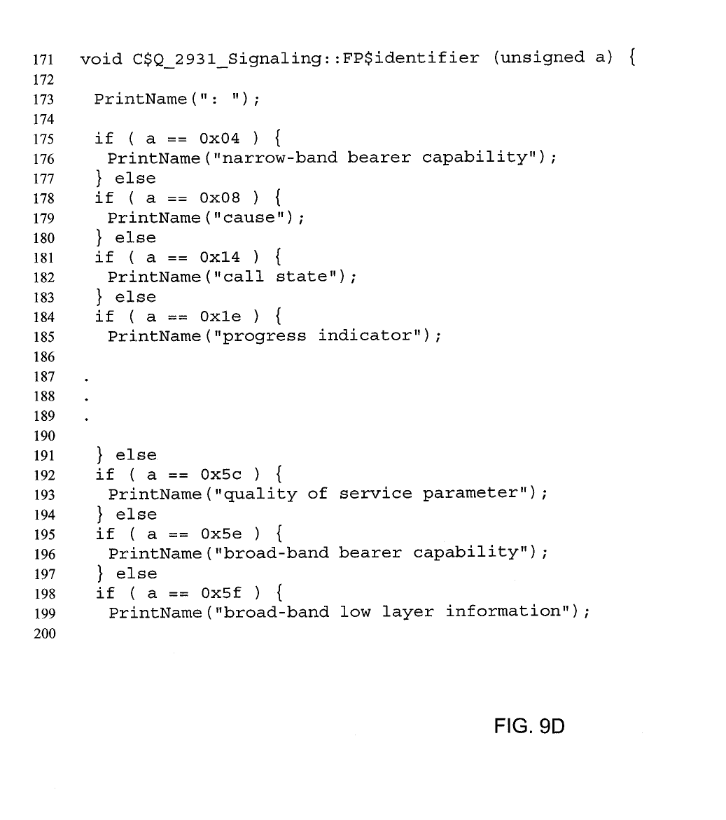

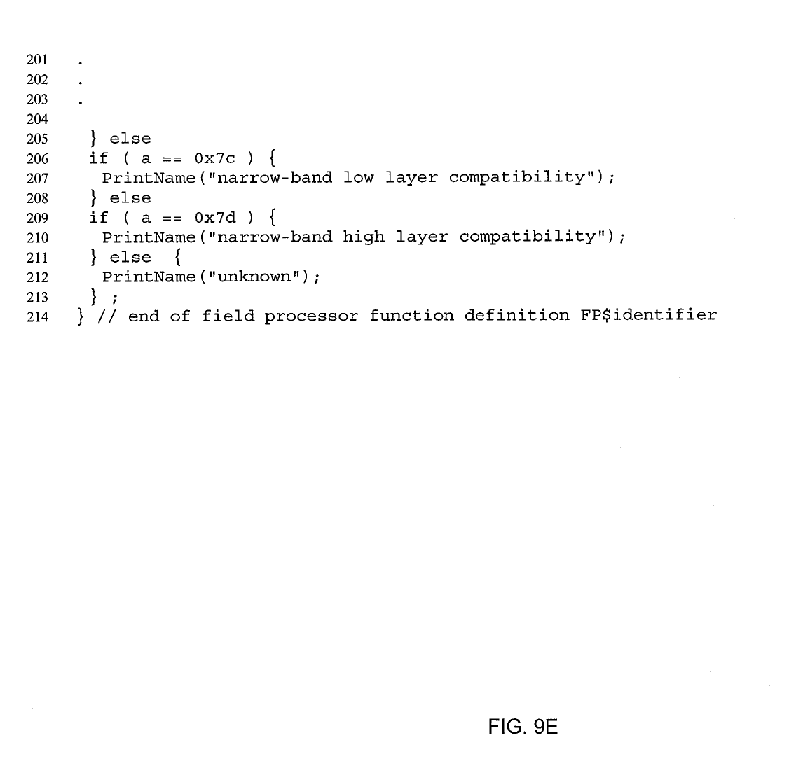

Referring back to FIG. 3, protocol specification 140 is processed by specification compiler 310 to produce packet decoder source code 320, which is later combined with message processing source code 325 to form executable software 340. Referring to FIGS. 9A-G, portions of the source code is illustrated. Referring to FIGS. 9A-C, the protocol specification shown in FIGS. 6A-B for the “information element” packet type is compiled into the C++ language to form the subroutine

C$Q_{—}2931_Signaling::PP$information₁₃ element( )

which is a method of the C$Q_{—}2931_Signaling object class. This subroutine begins at line 100 in FIG. 9A. Referring to lines 104-105, the value of the “identifier” field is first obtained using the Processfield( ) call, and then the value of the field is stored in the global variable V$FP$identifier. In line 105, the message processing function FP$identifier( ) is called with the parameter value for the identifier field in the packet. This procedure of obtaining field values and the calling the appropriate message processing function is repeated in lines 160-117, corresponding to lines 132 through 143 in the specification in FIG. 6A. At line 118 in FIG. 9A, the len construct used in the protocol specification is translated to the SetPduLen( ) call which resets the length of the packet being processed. The remainder of the PP$information_element( ) subroutine corresponds to the alt construct at lines 144 through 177 in the protocol specification in FIG. 6B. In particular, lines 144 and 145 correspond to line 157 in FIG. 6B, which corresponds to the special case of a broad-band bearer capability information element. At line 145 in FIG. 9B, PP$information_element( ) calls PP$broad_band_bearer_capability( ) to further process the packet if the value of identifier is 0x5e.

In this example, no actions are explicitly specified in the definition portions of the field specifications. As an option, specification compiler 310 generates implicit actions for each field, corresponding to a call to a subroutine that prints out the content of the field. Using this option, specification compiler 310 essentially produces a protocol analyzer (or “sniffer”) that can be used to monitor communication sent according to the specified protocol.

Turning now to FIGS. 9D-E, an example of a message processing routine, in this case for the identifier message, is shown. This routine is called from line 105 in FIG. 9A to process the identifier field. In the example in FIGS. 9D-E, the routine PrintName( ) is called to output the symbolic name associated with the value of identifier. Other message processing routines would act on the value in other ways.

Turning to FIG. 9F, the PP$broad_band_bearer_capability( ) routine at lines 215 through 256 corresponds to the “broad-band bearer capability” protocol specification at lines 100 through 128 in FIG. 8. As in the PP$information_element( ) routine, field values are each obtained in turn by a call to ProcessField( ) and then stored in a global variable, for example in lines 219 and 220 for the “ext bit” field.

5 Alternative Embodiments

Other software-based embodiments, which use the same protocol specification syntax, use different approaches to communicating the field values in an input packet to the message processor (see FIG. 1), or to a state machine and a packet generator (see FIG. 2). For instance, rather than passing field values a parameters in messages or subroutine calls, the values can be passed through a shared field storage in which field names are associated with field values.

In other embodiments, rather than generating source code from a protocol specification, which is in turn compiled into executable software, the protocol specification is preprocessed to produce a binary form and which is then interpreted by software in the communication processing device at run time. In one example of preprocessing, the protocol specification, which is input as readable text, is processed into a data structure that more efficiently encodes the same information.

In other embodiments, rather than using a general-purpose processor or controller to process the input packets based on the protocol specification, a customized processor is used. The customizations include instructions that are specially tailored for processing the input packets. These tailored instructions are called directly in source code obtained by processing the protocol specification, or are called by an interpreter that processes the protocol specification, or an equivalent data structure, at run time.

In other embodiments, customized hardware is designed from the protocol specification. For instance, rather than processing the protocol specification to produce a source code in a procedural programming language, the protocol specification is translated into a hardware description language (e.g., Verilog) that is then processed by hardware design software to specify customized integrated circuits.

Still other embodiments use a combination of generation of program source code, data structures describing the protocol specifications, and hardware specification from the protocol specification.

Other embodiments make use of parallel processing to implement the packet decoder. For example, packet decoder module 420 (FIG. 4) can be implemented on a multiple-processor computer. When a sub-packets of known length is encountered by the packet decoder, the processing of that sub-packet is performed on another processor in parallel while processing of the packet continues with the portion following that sub-packet. In order to ensure proper interpretation of incoming packets, the protocol specification can optionally include statements that indicate that particular sub-packets can be safely processed in parallel.

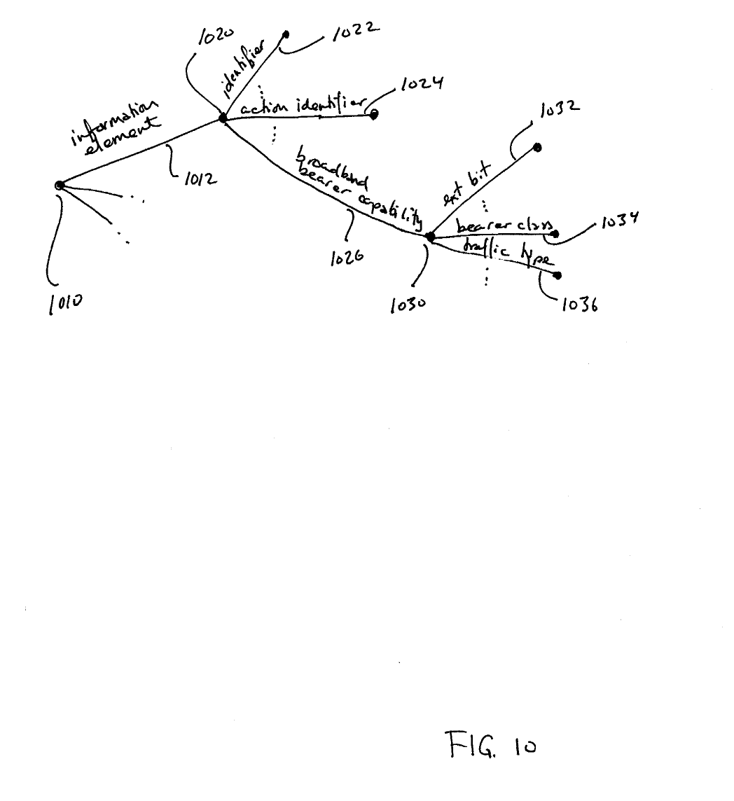

Another view of the process of creating a hardware or software implementation according to a protocol specification is to arrange the nested sub-packets and fields in a tree structure, a direct solution tree, with actions associated with leaves and possibly internal nodes of the tree. Referring to FIG. 10, a portion of such a tree structure are shown for the example specification in FIGS. 6A-B and FIG. 8. A root node 1010 corresponds to any type of input packet. A branch 1012 corresponds to a information element packet, defined at line 100 in FIG. 6A. Branch 1012 terminates at a node 120, from which branches originate corresponding to the various sub-packets and fields of an information element packet. For example, a branch 1022 corresponds to an identifier field (line 101, FIG. 6A), a branch 1022 corresponds to the action identifier field (line 142, FIG. 6A), and a branch 1026 corresponds to the broadband bearer capability sub-packet (line 158, FIG. 6B). Branch 126 terminates at a node 130 which is the root of branches corresponding to the sub-elements of a broadband bearer capability sub-packet. For example, branch 1032 corresponds to the ext bit field (line 101, FIG. 8), branch 1034 corresponds to the bearer class field (line 103, FIG. 8), and branch 1036 corresponds to the traffic type field (line 107, FIG. 8). Note that only a small number of paths through such a tree are taken for any one packet, and the same path may be taken multiple times, for example, if the same sub-element of a packet is repeated multiple times.

In various embodiments, packet detector 120 (see FIG. 1) uses hardware approaches, software approaches, or a combination of hardware and software approaches to determine the boundaries of individual packets. In addition, packet detector 120 can alternatively also perform a packet assembly function in which it detects multiple packets, but it assembles the individual packets to form a larger packet before forwarding that larger packet to packet decoder 110. An example of such packet assembly may be found in an ATM-based system in which packets each split into a series of ATM cell payloads, and then the packet detector reassembles the larger packets before further decoding. In the case of electrical characteristics of data signal 125 signifying packet boundaries, packet detector 120 includes electronic circuitry for identifying the packets, and for converting the content of the packet into a finite-length digital bitstream of the information in the packet. In the case that packet boundaries are identified in the bit stream itself, packet decoder 110 takes a continuous digital bit stream transmitted in data signal 125 and sends finite length subsequences of bits to packet decoder 110. Packet decoder 110 receives the bit stream, and processes the content of the bit stream.

In the description in Section Error! Reference source not found. above, a particular syntax for the protocol specification is described. In other embodiments, other specification can be used. For example, other types of phrase-structured grammars can be used to describe the nested structure of packets, sub-packets, and fields in a packet. As in the above embodiment, the packet decoder parses the input packet based on the grammar to determine the nested boundaries of packets (phrases, non-terminal elements) and fields (terminal elements), and then issues messages based on the resulting parse of the input packet.

Related embodiments of the invention are applicable in areas other than data communication in which processing of information sequences with complex structures is required. One such embodiment is in the area of chemical analysis in which an automated chemical analyzer creates a sequential description from a sample of a chemical using well known chemical analysis techniques. This sequential description is then fed to a “decoder” that accepts a chemical specification that has a similar form to the protocol specification described in other embodiments. In particular, the chemical specification includes definitions of typically nested constituents that may be found in the sequential description, as well as associated actions to take when those constituents are found. In another embodiment, a similar approach can be taken to analyze complex DNA sequences using a DNA specification that is analogous to the protocol specification used in the communication-related embodiments.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. An optical data signal processing system comprising
an optical signal router comprising a plurality of optical switches arranged in a connection structure, each switch having at least one optical input port, at least a first and a second optical output port, and an optical control port for controlling the optical connection of a switch input port to one of the switch's output ports,
an optical control generator comprising a plurality of electrically controlled optical energy sources, each source being optically connected to at least one of said optical control ports, each source having an electrical signal input control port and an optical energy output port in response thereto, and
a processor translation system for flexibly generating and controlling electrical signals input to a plurality of said electrical control ports of said optical sources for configuring said connection structure for managing the optical route of an optical data input signal through the processing system to a processing system selected output.

2. The optical signal processing system of claim 1 wherein said processor translation system comprises a processor for implementing software instructions for:
accepting a protocol specification that includes a plurality of specifications of element input/output relationships, wherein the specifications of at least some of the elements are in terms of sequences of other of the plurality of elements,
associating portions of said specification with control levels of said electrical signals; and
for each of the associated portions providing instructions to said processor, the instructions for setting said associated control levels for controlling at least some of said optical sources.

3. The system of claim 2 wherein accepting the protocol specification includes accepting a specification for a logic structure protocol.

4. The system of claim 2 further comprising instructions for processing the protocol specification to produce executable software that implements associating the control lines with elements specified in the specification.

5. The system of claim 2 wherein the specification includes an object-oriented specification of elements.

6. The system of claim 2 wherein the specification includes for at least some of the elements an association of a numerical value identifying said element with a symbolic name for said element.

7. The system of claim 2 further comprising instructions for processing the specification to produce a hardware description, and deriving from said hardware description the electrical control signals.

8. The system of claim 3 wherein accepting the logic structure specification comprises accepting sufficient information for unambiguously processing the specification for associating different portions of the specification with different control lines of the optical sources.

9. The system of claim 1 wherein said processor translation system comprises
a protocol translation system for receiving a protocol specification regarding incoming packets of data over an optical system and outputting electrical control signals to the optical control generator, for causing said generator to output generator optical signals for configuring optical switches of the optical signal router through said optical sources.

10. The system of claim 9 further wherein said processor translation system acts through said optical control generator to configure a first portion of said optical switches as an optical processor for optically processing optical data of an optical data input packet in accordance with said protocol specification for determining the destination of said packet, and
said first portion of said optical switches provides optical control signals to a second portion of said optical signal router for directing said input optical signal to the processing system output port identified by said optical processor.

11. The system of claim 10 wherein said second portion of said optical signal router has a configuration of a binary tree structure.

12. The system of claim 11 wherein said first portion of said optical switches operates to control the operation, at any one time, of less than all of said second portion of said optical switches.

13. The system of claim 12 wherein the number of second portion optical switches being controlled, at any one time, is N where (2^{N}−1) is less than the number of output destination ports of the system.

14. The system of claim 1 wherein said optical signal router comprises
a first level optical configuration processor, and
a second level optical signal path configuration processor,
said first level optical processor having a structural configuration, which, in response to optical signals from the optical control generator optical energy output port, enables said first level processor to receive and optically decode optical input packets of an optical data input signal,
said second level optical processor, in response to optical signals from said first level processor, providing an optical path from an optical data input to the processing system selected output.

15. The optical signal processing system of claim 14 wherein said processor translation system comprises a processor for implementing software instructions for:
accepting a protocol specification that includes a plurality of specifications of element input/output relationships for decoding received input packets,
associating portions of said specification with control levels of said electrical signals; and
for each of the associated portions providing instructions to said processor, the instructions for setting said associated control levels for controlling an interconnection configuration of at least some of said optical sources.

16. The system of claim 15 wherein accepting the protocol specification includes accepting a specification for a logic structure protocol.

17. The system of claim 15 further comprising instructions for processing the protocol specification to produce executable software that implements associating the control lines with elements specified in the specification.

18. The system of claim 15 wherein the specification includes an object-oriented specification of elements.

19. The system of claim 15 further comprising instructions for processing the specification to produce a hardware description, and deriving from said hardware description the electrical control signals.

20. The system of claim 14 further wherein said second level optical processor has a configuration of a binary tree structure.

21. The system of claim 20 further wherein said first level optical processor provides less than N+1 deterministic optical signals to the second level optical processor, where N has a value such that (2^{N-1}) is less than the number of output destination ports of the processing system, and N is greater than 2.

22. The system of claim 14 further comprising
a look-up table storing at each of a plurality of addressable locations, a control word for controlling the optical signals to be sent by said first level processor to said second level processor, and
said first level processor determining a location to select in response to optically decoding an incoming optical data packet.

23. An optical data signal processing method comprising
arranging a plurality of optical switches in a connection structure, each switch having at least one optical input port, at least a first and a second optical output port, and an optical control port for controlling the optical connection of a switch input port to one of the switch's output ports,
optically connecting each of a plurality of electrically controlled optical energy sources to at least one of said optical control ports,
connecting to each source an electrical signal input control signal and providing an optical energy output signal in response thereto; and
flexibly generating and controlling electrical signals input to at least a plurality of said optical sources for managing the optical route of an optical data input signal through the processing system to a processing system selected output.

24. The method of claim 23 further comprising
receiving a protocol specification regarding incoming packets of data being input over an optical system, and
outputting the electrical control signals to the energy sources, for causing said sources to output optical signals for configuring the optical switches.

25. The method of claim 24 further comprising
configuring a portion of said optical switches as an optical processor for optically processing optical data of an optical data input packet in accordance with said protocol specification for determining the destination of said packet, and
providing optical control signals for directing said input optical signal to an identified destination.

26. The method of claim 24 further comprising
receiving a second protocol specification regarding incoming packets of data being input over the optical system, and
outputting a second set of electrical control signals to the energy sources for reconfiguring the outputs of said sources, for causing said sources to output optical signals for reconfiguring the optical switches.

27. An optical data signal processing system comprising
router means comprising a plurality of optical switch means arranged in a connection structure, each switch having at least one optical input port, at least a first and a second optical output port, and an optical control port for controlling the optical connection of a switch input port to one of the switch's output ports,
an optical control generator means comprising a plurality of electrically controlled optical energy source means, each source means being optically connected to at least one of said optical control ports, each source means having an electrical signal input control port and an optical energy output port in response thereto; and
means for flexibly generating and controlling electrical signals input to at least a plurality of said control ports of said optical source means for managing the optical route of an optical data input signal through the processing system to a processing system selected output.

28. The system of claim 27 wherein said generating and control means comprises
means for receiving a protocol specification regarding incoming packets of data over an optical system, and
means for outputting the electrical control signals to the optical control generator means, for causing said sources to output optical signals for configuring the optical switches.

29. The system of claim 28 further comprising
means for configuring a portion of said optical switches as an optical processor for optically processing optical data of an optical data input packet in accordance with said protocol specification for determining the destination of said packet, and
means for providing optical control signals for directing said input optical signal to the system output port identified by said protocol translation system.

30. An optical data signal processing system comprising
means for arranging a plurality of optical switches in a connection structure, each switch having at least one optical input port, at least a first and a second optical output port, and an optical control port for controlling the optical connection of a switch input port to one of the switch's output ports,
means for optically connecting each of a plurality of electrically controlled optical energy sources to at least one of said optical control ports,
means for connecting to each source an electrical signal input control signal and providing an optical energy output signal in response thereto; and
means for flexibly generating and controlling electrical signals input to at least a plurality of said optical sources for managing the optical route of an optical data input signal through the processing system to a processing system selected output.
